(19) United States
(12) Patent Application Publication
(10) Pub. No.: US 2008/0284854 A1
(43) Pub. Date: Nov. 20, 2008

(54) System and method of static pattern removal from movies captured using a digital CCD camera

(75) Inventor: Kimball Darr Thurston, III, Los Angeles, CA (US)

Correspondence Address: DTS, INC., 5171 CLARETON DRIVE, AGOURA HILLS, CA, 91301, US

(73) Assignee: DTS, Inc.

(21) Appl. No.: 11/804,416

(22) Filed: May 18, 2007

(51) Int. Cl. H04N 5/225; H04N 9/64

(52) U.S. Cl. 348/207.1; 348/246

(57) ABSTRACT

An efficient and robust mechanism for static pattern removal from movies captured with a digital CCD camera. A correction map of malfunctioning underexposed CCD pixels is provided and applied to each image in the affected shot to correct the malfunctioning pixels. The correction map may be associated with the specific images in a given shot or with a particular CCD camera. The entire process, other than possibly the initial step of determining which shots to correct, is fully-automated on a computer workstation. The computer generates the correction map, applies it to each image and validates the correction. This is a considerably more efficient approach than one in which a technician must determine there is a problem of under exposure, identify the malfunctioning pixels in each frame and manually retouch the affected pixels.

### BACKGROUND OF THE INVENTION

1. Field of the Invention

This invention relates to the use of digital CCD cameras to capture movies, and more particular to a system and method of removing static patterns in the captured sequence of digital images caused by under exposure when using a CCD camera.

2. Description of the Related Art

Historically motion pictures have been recorded using analog film cameras, post-processed using analog techniques and released on film for exhibition using analog film projectors. A small but rapidly growing number of motion pictures are being released by replacing one or more of these conventional analog technologies with digital technologies. Digital cinema or ‘D-Cinema’ specifies a uniform digital format for releasing motion pictures for exhibition using digital projectors. A Digital Intermediate or ‘DI’ process is replacing analog film techniques in post-production. Lastly, film cameras are being replaced by high-resolution digital CCD (charge-coupled device) cameras that capture the motion picture as a sequence of digital color images at high resolution, e.g. 2K (2048×1080 pixels) or 4K (4096×2160 pixels) per color component.

A CCD camera is an image sensor consisting of an integrated circuit containing an array of linked, or coupled, light-sensitive devices (pixels). CCD imaging is performed in a three step process: (1) exposure which converts light into an electronic charge at discrete pixels, (2) charge transfer which moves the packets of charge within the silicon substrate, and (3) charge to voltage conversion and output amplification to read out the image. An image is acquired when incident light, in the form of photons, falls on the array of pixels. The energy associated with each photon is absorbed by the silicon and causes a reaction to take place. This reaction yields the creation of an electron-hole charge pair. The number of electrons collected at each pixel is linearly dependent on exposure level.

CCDs follow the principles of basic Metal Oxide Semiconductor (MOS) device physics. A CCD MOS structure simply consists of a vertically stacked conductive material (doped polysilicon) overlying a semiconductor (silicon) separated by a highly insulating material (silicon dioxide). By applying a voltage potential to the polysilicon or “gate” electrode, the electrostatic potentials within the silicon can be changed. With an appropriate voltage a potential “well” can be formed which has the capability of collecting the localized electrons that were created by the incident light. The electrons can be confined under this gate by forming zones of higher potentials, called barriers, surrounding the well. Depending on the voltage, each gate can be biased to form a potential well or a batter to the integrated charge. Once charge has been integrated and held locally by the bounds of the pixel architecture, the charge packets are transferred to a sense amplifier that is physically separated from the pixels to read out the image. Silicon based CCDs are monochrome in nature. Color images are generated using a single CCD image and a color wheel or a filter or using three separate CCD imagers tuned to the red, green and blue spectra, respectively.

### SUMMARY OF THE INVENTION

The present invention provides an efficient and robust method and system for static pattern removal from movies captured with a digital CCD camera.

This is accomplished by receiving a sequence of digital moving images captured with a digital CCD camera and providing a correction map of malfunctioning underexposed CCD pixels. The correction map is applied to the digital moving images to reduce the effects of malfunctioning underexposed CCD pixels. The correction map may be generated from the sequence of images itself or generated off-line and associated with the particular camera used to capture the images. The correction map may include actual malfunctioning pixel output values to be subtracted from the images or may represent a binary map of malfunctioning or possibly malfunctioning pixels used to spatially filter the malfunctioning pixels. A validation step may be performed to ensure that the identified pixel is in fact malfunctioning in each image and should be corrected. The entire process may be fully automated on a computer workstation. Determining which ‘shots’ (sequences of images) to process may be performed manually or automated as well.

In one embodiment, the received sequence of digital moving images has an approximately uniform exposure level. Each image is high pass filtered to preferably isolate single pixel spikes that represent either image detail or an aberration due to a malfunctioning underexposed pixel. The filtered images are averaged together to generate a correction map of the malfunctioning pixels for each color component. The aberrations are spatially fixed and temporally persistent and thus reinforced by averaging whereas image detail is generally attenuated by averaging. Image content may completely or partially mask pixels that would otherwise malfunction at the exposure level for the image. As such, the correction map corresponds to this particular sequence of digital moving images. The correction map is than applied to the digital moving images to reduce the effects of the malfunctioning underexposed CCD pixels. The correction map may be applied by subtracting it from each image (per color component). This may be preceded by a correlation step between the correction map and the filtered image to determine which pixels to correct; as some pixels in a given image may be masked by brighter content. Or the correction can be validated by comparing the pixel value to its nearest neighbors. Alternately, the correction map may be represented and used as a binary map to identify potentially malfunctioning underexposed pixels. Again, the map may be correlated to each filtered image to identify the actual malfunctioning pixels in each image. A local spatial filtering is than performed on each malfunctioning pixel. Instead of or in addition to the correlation step, the filtered pixel value can be compared to the original pixel value. If the difference is greater than some specific value, the filtered pixel value is kept otherwise the original pixel value is kept.

In another embodiment, the received sequence of digital moving images is associated with a particular CCD camera. A correction map of malfunctioning underexposed CCD pixels for that particular CCD camera is retrieved from an inventory generated by the camera manufacturer. The correction map is used to selectively spatial filter the digital moving images to replace the malfunctioning underexposed CCD pixels. The correction map is a binary map of all pixels that malfunction at some level of under exposure for the particular CCD camera. As such the correction map is generally over inclusive for pixels that actually malfunction at a specific level of under exposure. A correlation and/or validation step is used to down select the actual malfunctioning pixels in each image.

These and other features and advantages of the invention will be apparent to those skilled in the art from the following detailed description of preferred embodiments, taken together with the accompanying drawings, in which:

### BRIEF DESCRIPTION OF THE DRAWINGS

FIGS. 1a and 1b are diagrams of a static pattern produced by a digital CCD camera when underexposed;

FIG. 2 is a plot of exposure level for a number of different shots of a movie;

FIGS. 3a and 3b are a workstation and flowchart of a method of removing static patterns due to underexposure from a movie shot with a digital CCD camera;

FIG. 4 if a flowchart of one embodiment of the method in which the correction map is extracted from a sequence of images for an unknown camera and unknown exposure level;

FIGS. 5a-5c are a sequence of digital images that exhibit a static pattern due to underexposure;

FIGS. 6a-6c are diagrams of the high-pass filtered images;

FIG. 7 is a diagram of a correction map extracted from the sequence of digital images;

FIGS. 8a and 8b are alternate embodiments for using the correction map to correct the digital images;

FIG. 9 is a diagram illustrating the correlation of the correction map with the second high-pass filtered image to identify malfunctioning pixels and masked pixels;

FIG. 10 is a corrected digital image; and

FIG. 11 is a flowchart of an alternate embodiment of the method in which the correction map is generated for a specific CCD camera over a range of under exposure levels.

### DETAILED DESCRIPTION OF THE INVENTION

The present invention describes an efficient and robust mechanism for static pattern removal from movies captured with a digital CCD camera. A correction map of malfunctioning underexposed CCD pixels is provided and applied to each image in the affected shot to correct the malfunctioning pixels. The correction map may be associated with the specific images in a given shot or with a particular CCD camera. The entire process, other than possibly the initial step of determining which shots to correct, is fully-automated on a computer workstation. The computer generates the correction map, applies it to each image and validates the correction. This is a considerably more efficient approach than one in which a technician must determine there is a problem of under exposure, identify the malfunctioning pixels in each frame and manually retouch the affected pixels.

Ideally, all of the pixels in the CCD camera (a) are good, as in functioning under normal exposure levels, (b) exhibit inter image uniformity, as in the same threshold and slope for each pixel, (c) exhibit intra image uniformity, no pixel noise and (d) return a value around “black” (zero) if underexposed, as in the total light is less than the threshold. Although materials and manufacturing processes continue to improve the uniform manufacturer of CCD pixels across a high-resolution large area format remains a challenge. Images that have too many ‘bad’ pixels are discarded. Camera makers build maps of bad pixels and corrections into the capture and transfer mechanisms in the image. Inter and intra image pixel non-uniformity is also correctable via other known mechanisms.

Each pixel has to receive a certain amount of light (e.g. above the threshold) to respond in this mostly uniform way. The pixels are designed and a majority of them will return a value around “black” (zero) if they are under exposed. However, a few pixels may respond incorrectly and report that they received more light than they did producing a bright pixel in what should be a black background. When a pixel is underexposed, the voltage applied to the gate electrode is too small (e.g. less than the threshold) to cause the MOS structure to reliably operate in its linear region. The structure is unstable and may randomly switch to a high output value. The CCD pixel functions correctly under normal exposure, but in an under exposed situation, the pixel reports an erroneous reading. This form of noise is referred to as “dark current” noise. The percentage of malfunctioning pixels is generally fairly small but prevalent enough that this type of artifact is easily noticed when watching images in motion as a ‘screen door’ effect and quite offensive. Traditional film processes also suffer from this type of noise, but can work around it by a process called ‘flashing’ the film, where film is initially exposed to a very low amount of light to get it to the threshold where low light conditions are already in the response range. This is possible with CCD cameras if a light ring is used, although that practice is hard to accomplish in practice, so a post processing solution is desired.

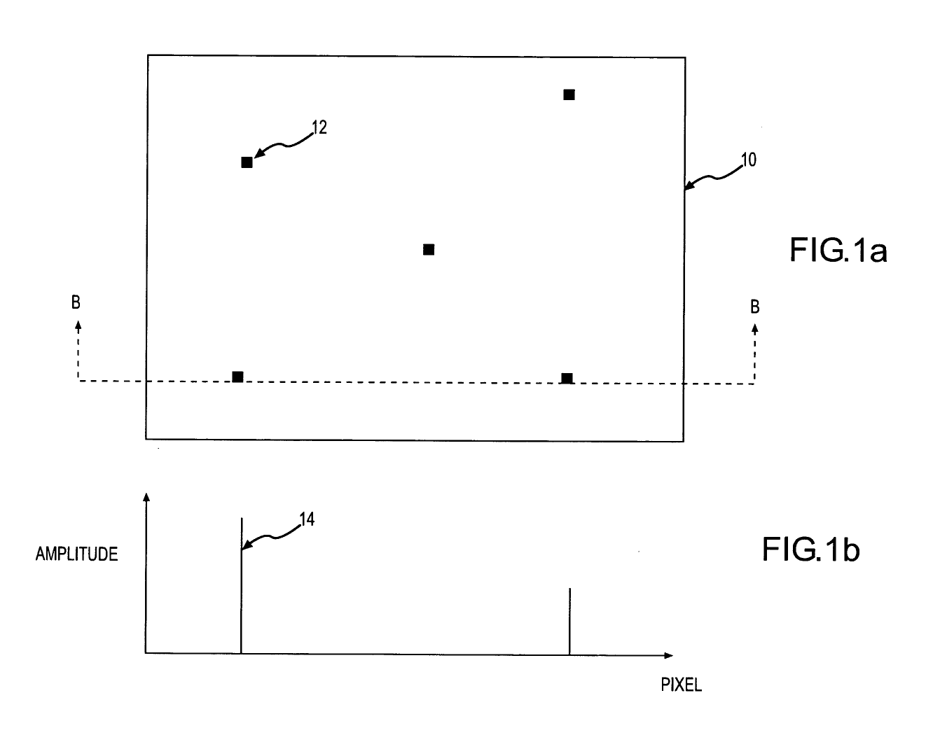

A static pattern 10 for a given exposure level less than the threshold is illustrated in FIGS. 1a and 1b. In this case, the static pattern is generated by taking a picture (no content) at a specific exposure level that is less than the threshold of the image. As shown, a few random pixels 12 return a high output value 14. The output value 14 may vary with pixel and/or exposure level. A given pixel will typically report the same incorrect reading in response to the same under exposed light level. But a pixel that is malfunctioning at one underexposure level may not malfunction at a different underexposure level. In addition, a pixel that one would expect to malfunction at a given underexposed level for the image may not malfunction on account of relatively brighter content in the area of the pixel in actual imagery. As a result, the static pattern varies with the camera, exposure level and local content of a scene.

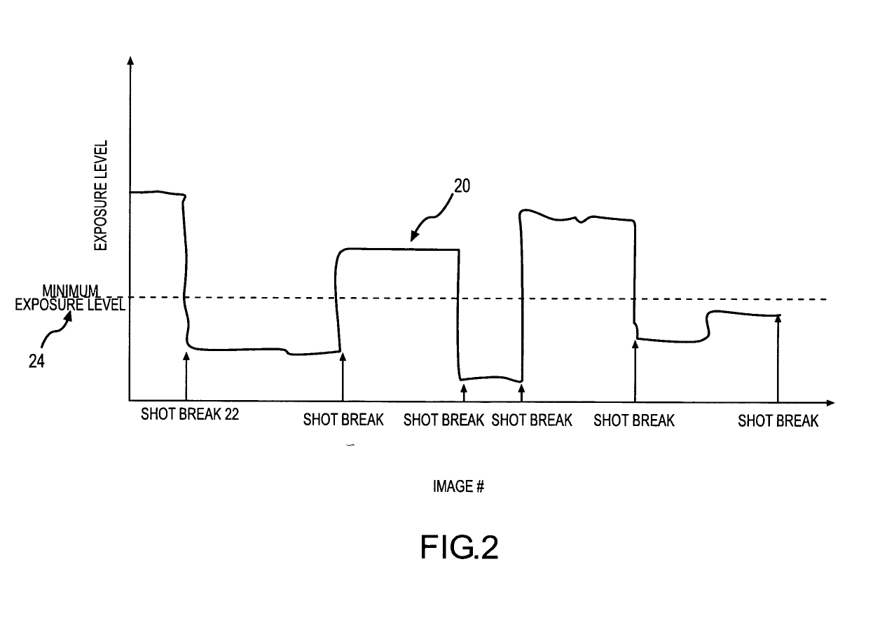

The exposure level 20 for a portion of a movie captured with one or more digital CCD cameras is illustrated in FIG. 2. Typically, the sequence of digital moving images for a particular shot are received and processed separately and not as a single sequence and the incidence of underexposure is fairly rare, not fifty percent as illustrated. For purposes of illustration the shots are concatenated and every other one is under exposed. The ‘shot breaks’ 22 are either known or easily extracted using known techniques.

The exposure level in a CCD camera is determined by three factors: the sensitivity of the CCD camera to visible light, the intensity of illumination, and the rate of capture which translates into integration time allowed to the CCD. The director of photography (DP) and/or camera operator will adjust one or more of these factors for a given shot to achieve a desired ‘look’. High-speed photography for visual effects inherently lowers integration time which additionally increases the chances for dark current noise patterns to appear. The camera may provide an ‘exposure level indicator’ as a function of these factors to indicate whether the exposure is normal, under or over. However, these indicators are merely a guide and may not reflect the optimum conditions the DP desires. Providing the correct exposure to match the dynamic range of the content being imaged with the sensitivity and dynamic response of the camera system is important. Exposure also controls the level of brightness, color saturation and contrast in the captured image.

Once these factors are set, the exposure level 20 will remain relatively constant from image-to-image for a given shot. In the last shot, the exposure level does change midway through due, for example, to a change in lighting conditions or the brightness of the image content itself. The brightness within a frame may vary with content and the brightness for a given pixel from image-to-image may vary with changes in content. The exposure level 20 will typically vary from shot-to-shot with some shots being normally exposed and others under exposed.

Because the use of digital CCD cameras is relatively new in filming motion pictures and notwithstanding the camera's ‘exposure level indicator’, DPs and cameramen are still forced to capture images under conditions not ideal for CCD cameras, because of a desired look or other special effects filming, and do not yet have the tools to handle these situations. As a result, occasionally a shot will be under exposed, i.e. the exposure level 20 for the shot will be less than a minimum exposure level 24 required for the CCD imager to function properly. These aberrantly bright pixels in a dark area of an underexposed shot are very noticeable and unacceptable artifacts. If the problem is discovered in a timely manner, the scene may be reshot if lighting conditions can be changed. If not, all of the malfunctioning underexposed pixels in each image of the shot must be retouched. To do this manually would be very labor intensive.

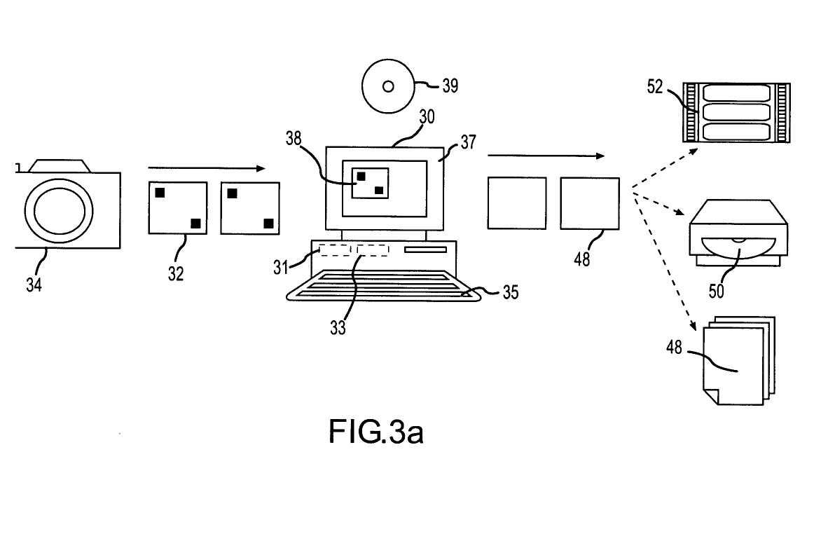

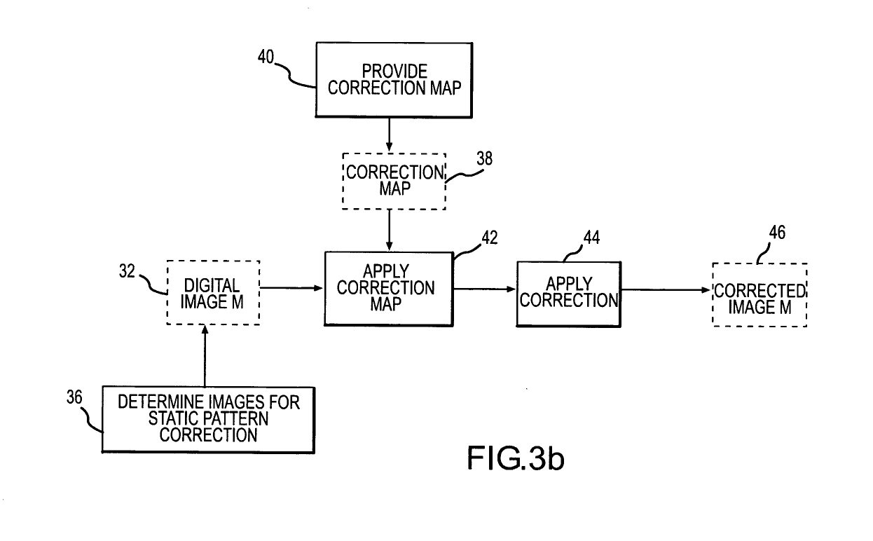

A workstation 30 and method of static pattern removal from movies captured with a digital CCD camera is illustrated in FIGS. 3a and 3b in accordance with the present invention. The purpose of static pattern correction is to preserve image structure and detail, including per-image noise, and to only remove the errant readings from the images. According to an embodiment of the invention, a sequence of digital moving images 32 captured by a digital CCD camera 34 is input to workstation 30 that suitably includes a storage unit 31, a processor 33, input means 35 including a keyboard and/or mouse and a display 37. The workstation will typically include a software application for configuring the processor 33 to automatically perform certain steps to perform static pattern removal and a software tools for configuring the processor 33 to enable a user to select images for processing. The software application and/or tools may be provided as computer program logic recorded on a computer useable medium 39 and download to the storage unit and processor.

The workstation or a technician using the workstation will determine whether the images or a subset of the images require static pattern correction, i.e. was the shot under exposed? (step 36). There are many options as to how this determination may be made. A technician may view the images at regular speed looking for any number of different artifacts and may notice that the shot appears to be underexposed and exhibit a static pattern of aberrantly bright pixels. The workstation processor may be configured to measure the average picture level as an approximation of exposure level from the images and decide whether to process or not. Alternately, all images may be automatically fed through the process. For normally exposed images, the correction map will be blank and no correction will be applied to those images. In the case of the last shot shown in FIG. 2 in which the exposure level changes, the technician or processor may break the sequence into two separate sequences each having an approximately uniform exposure level.

The next step is to provide the correction map 38 (step 40) for either the particular sequence of digital images 32 being processed or the particular CCD camera 34 used to capture the images. The correction map may be (a) binary in which zeroes indicate a functioning pixel and ones indicate a malfunctioning or potentially malfunctioning pixel due to under exposure or (b) multi-valued in which zeroes again indicate functioning pixels and non-zero values represent the time-averaged output value of the malfunctioning pixels (for each color component). Small non-zero values may be noise and can be set to zero or not. The map for a particular CCD camera will only be a binary map whereas the map generated for a sequence of images may be either binary or multi-valued. The multi-valued maps, one per color component, computed for a given sequence can be combined and thresholded to form a binary map. Alternately, a single color component of the multi-valued map may be computed and thresholded to form the binary map. The correction map is suitably stored in storage unit 31.

The workstation processor than applies the correction map (step 42) to each digital image 32 in the sequence to reduce the effects of malfunctioning under exposed pixels. How the map is applied depends on the type of map, binary or multi-valued, the amount of computing resources dedicated to this process, and whether the corrected pixel value is validated (step 44) or not. In general, the processor subtracts the multi-valued map from the original images to reduce the brightness of the malfunctioning pixels or uses the binary map to identify the malfunctioning pixels, which are then spatially filtered to generate a corrected output value. Because the correction map is generally over inclusive for any single image, application of the entire map to each image may apply a correction to pixels that are functioning normally due to locally bright image content. This approach is simple but may induce artifacts albeit less offensive ones; a darkened pixel within image content is far less offensive than a single bright pixel in a dark background. Alternately, the map (or a variant thereof including one component of the map or a combination of the components) may be correlated against each image (or a filtered version thereof) to identify only those pixels that are actually malfunctioning in each image. Thereafter the subtraction or spatial filtering can be limited to the identified malfunctioning pixels.

Instead of or in addition to the correlation step, the workstation processor may be configured to validate the correction of each malfunctioning pixel (step 44). The correction algorithm is based on the assumption that under exposed malfunctioning pixels produce aberrantly bright pixels in a dark background and that the algorithm replaces the bright pixels with a relatively dark pixel. Therefore, the corrected pixel and its neighboring pixels should have output values that are relatively dark and of similar value. If these conditions are not both true than the correction is not validated and the original pixel output value is kept. A number of different metrics can be used to determine whether the pixels are sufficiently dark and whether the corrected pixel is sufficiently close to its neighbors.

The workstation processor outputs the sequence of corrected digital moving images 46 that are suitably stored back on storage unit 31 (or a different storage unit). These images, which may be subjected to further processing during the movie making process, are then formatted and written out as a sequence of digital images 48 for D-Cinema distribution, formatted and written out to a physical media 50 such as disk or DVD, and/or formatted and written out to film 52. An appropriate mechanism such as an encoder, DVD burner or film writer may be used to write out the sequence of corrected images.

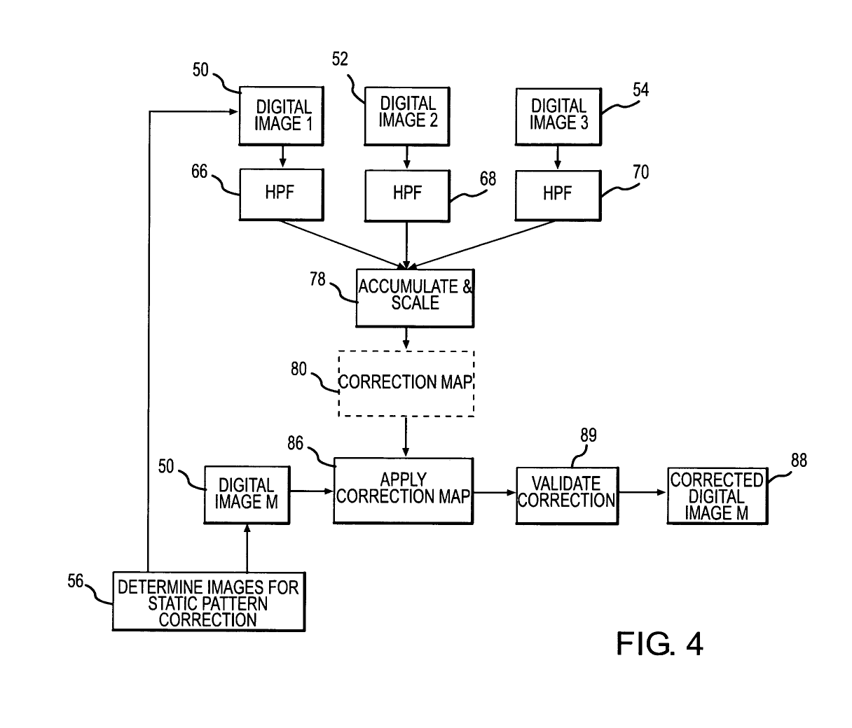

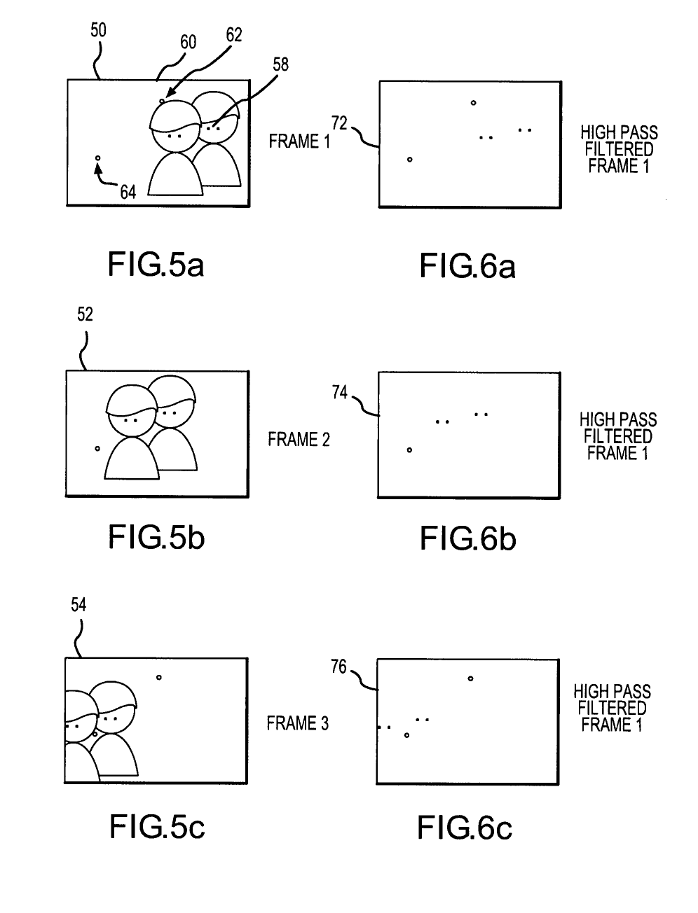

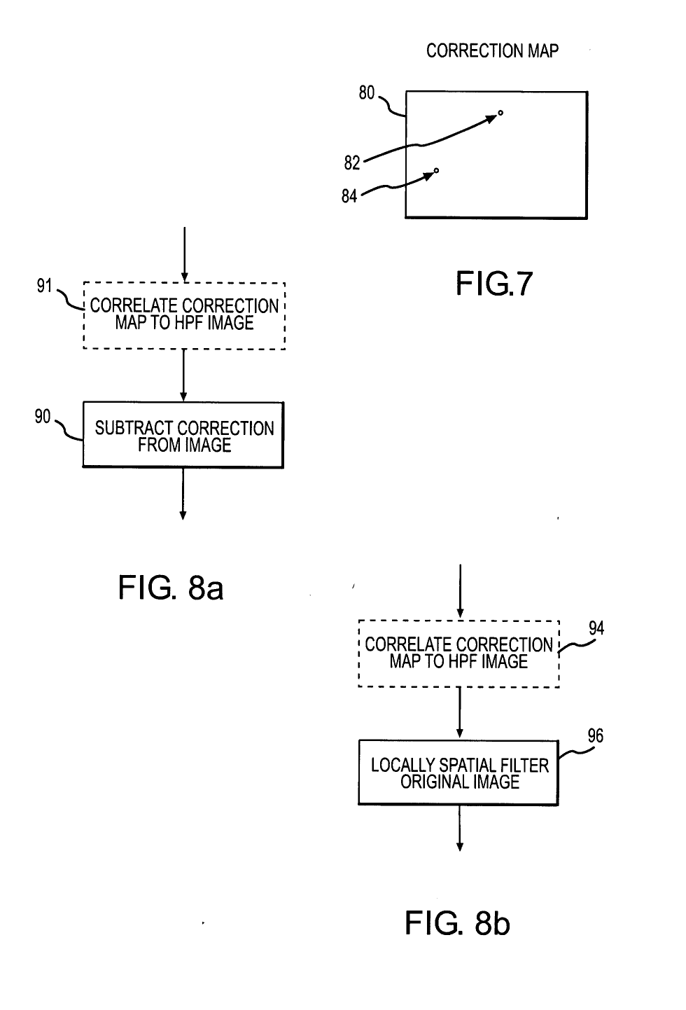

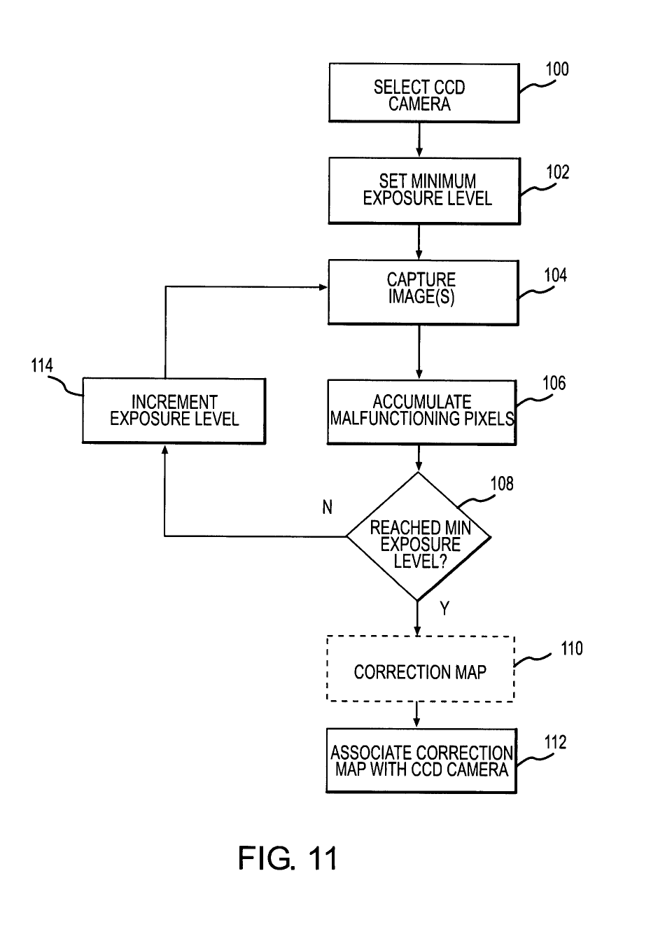

As described above, the correction map can be derived from the sequence of digital images to which the correction is applied as illustrated in FIGS. 4-10 or the correction map can be derived from a sequence of test images at varying exposure levels for a particular camera used to capture the current images as illustrated in FIG. 11. The former approach has the advantage that the technician/workstation does not have to know what CCD camera was used to capture the images, the CCD camera does not have to be characterized to generate a correction map and that map does not have to be properly tracked and made available to the technician/workstation. The post-house is not at the mercy of the camera manufacturer to provide a correction map. Furthermore, the correction map is at least somewhat tailored to the actually malfunctioning under exposed pixels in the sequence of images to be corrected. The latter approach has the advantage that the CCD camera can be evaluated once under carefully controlled conditions to generate the correction map and that map used to correct any images captured with that CCD camera at any amount of under exposure.

As shown in FIGS. 4-10, the workstation or technician determines that a sequence of three digital moving images 50, 52 and 54, which are under exposed and have an approximately uniform exposure level, require static pattern correction (step 56). Typical sequences would have hundred or thousands of images but three are sufficient to illustrate the technique. The images depict a person 58 moving right-to-left against an under exposed background 60. The exposure level in the background 60 is below the minimum exposure level therefore any content is lost. Most all of the pixels perform as designed, outputting a dark or zero value. However, two pixels 62 and 64 are malfunctioning, outputting a bright or non-zero value. Typical CCD elements would have a small percentage (1-5%) where the dark current noise is noticed when watching the images in motion, but 2 pixels are sufficient to illustrate the technique. Pixel 62 malfunctions in each of the images. Pixel 64 only malfunctions in the first and third images; the person moving through the pixel is sufficiently bright to cause the pixel to function properly even though the image as a whole is under exposed. The workstation processor high-pass filters each image (steps 66, 68 and 70) to form filtered images 72, 74, and 76. The filtered images are accumulated and scaled for each color component (step 78) to form a correction map 80. High-pass filtering removes low frequency structure within an image and also eliminates ‘ghosting’ where high amplitude, low frequency features could influence the average. Averaging, which is a temporal low-pass filtering operation, removes high-frequency motion and high-frequency temporal noise between the images. Together these two steps retain features that exhibit a high spatial frequency (e.g. a bright pixel in a dark background) and a low temporal frequency (e.g. persistent throughout the images). Image content that is fixed with respect to the camera throughout the sequence may contain strong edges that may at least partially survive the filtering operations producing ‘false positives’ in the correction map. This can be ameliorated by selecting a high-pass filter that looks for single-pixel anomalies, specifically single bright pixels in a dark background. The likelihood of adjacent pixels both malfunctioning is very low. Furthermore, a high-pass filter can be implemented by low pass filtering the image and than subtracting that image from the original image. The use of an edge preserving low pass filter core such as one described in “The Dual-Tree Complex Wavelet Transform: A New Efficient Tool for Image Restoration and Enhancement” by Nick Kingsbury will attenuate any edge content in the high pass filtered image. A single-pixel HPF using an edge-preserving LPF core was used in this example. The movement of person 58 across the scene would be sufficient to remove the edge around the person. However, if a white flag pole was fixed in the background, the filter would remove or at least greatly attenuate it in the high pass filtered images, hence the correction map.

As described previously, correction map 80 can be a single binary map or three multi-valued maps, one for each color component. The high-pass filtering and averaging process generates a multi-valued map for each color component in which malfunctioning pixels have a bright value and all other pixels have a zero or very small value. The workstation may perform a thresholding operation to set any value below some threshold to zero to get rid of any noise and truly isolate the malfunctioning pixels, although this is not necessary. Following the present example, assume pixels 62 and 64 both produce an output value of 128 in each color component when malfunctioning. These values are preserved during the HPF operation and than averaged to form bright pixel output values 82 and 84 in a dark background. Because pixel 62 malfunctioned in each image, its average value will remain 128. Because pixel 64 was masked by content in the second image, the HPF operation would set its output value to zero. As a result, the average value would be two-thirds of 128 or 85.3. To generate a binary correction map, the workstation simply thresholds one component multi-valued correction map or a combined multi-valued correction map and sets the values above the threshold to one. Alternately, the workstation could just use the multi-valued correction map as a binary map and ignore the specific output values.

Once the correction map is generated from the particular sequence of under exposed images, the workstation applies the correction map (step 86) to each of the digital images 50, 52 and 56 to form a sequence of corrected digital images as given by image 88 in which the static pattern has been removed. As described previously and shown in FIGS. 8a and 8b, there are at least two different ways to apply the correction map to the images. Each correction to each image may be validated as described above (step 89).

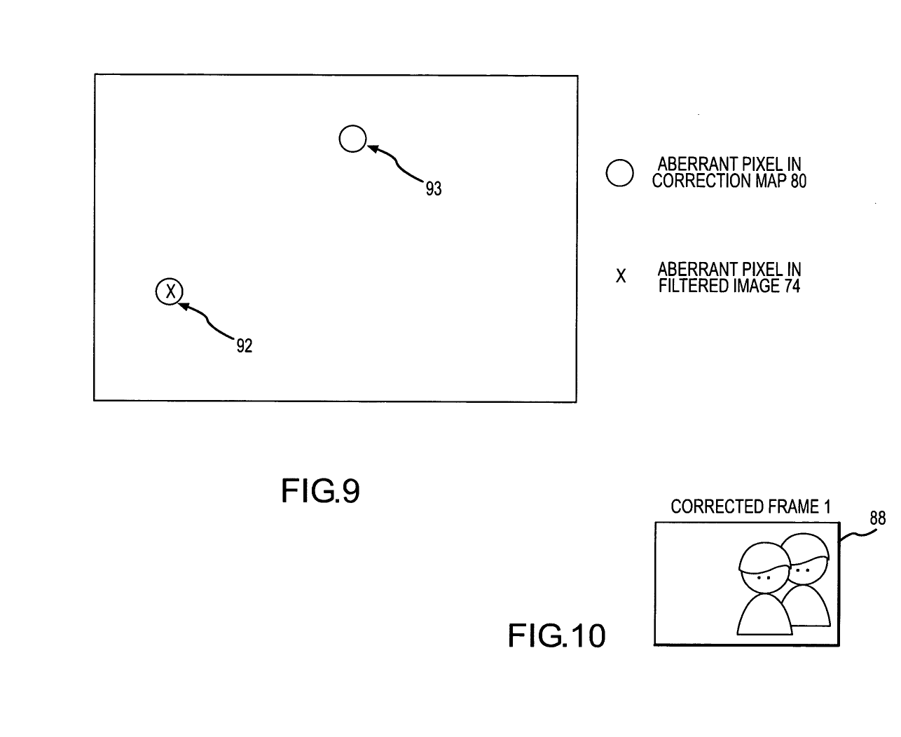

As shown in FIG. 8a, the simplest application of the multi-valued correction map, in which each malfunctioning pixel has three output values, one for each color-component, is to subtract the output values in the map from the output values in each digital image (step 90) for each pixel and each color component. The downside to this approach is that in certain images in the sequence a pixel that the map expects to malfunction may be masked by relatively bright content. Although the exposure level is less than the threshold, the content is bright enough that the pixel functions properly. The simplistic subtraction will actually create an artifact in what was a properly functioning pixel. This is ameliorated somewhat by the fact that (a) the time-averaged output value in the map will be smaller for pixels that are masked in some of the images and (b) the artifact caused by improperly reducing pixel brightness is far less offensive to a viewer than an aberrant bright pixel. The creation of artifacts can be eliminated by first correlating the correction map 80 to each filtered image exemplified by the second image 74 (step 91) as shown in FIG. 9 to overlay and align the correction map to the filtered image. If a pixel is bright or aberrant in both the correction map and the filter image, the subtraction is performed. In this example, subtraction is performed on the bottom left pixel 92 but not on the upper right pixel 93 where the aberrant pixel was masked by bright image content. Correlation can be performed on one color component, each color component or a combined image.

As shown in FIG. 8b, the binary correction map is used to identify malfunctioning pixels in each image and apply a local low-pass spatial filter to the identified pixels in each color component (step 94). The spatial filter replaces the aberrantly bright value with an average of the output values of the neighboring pixels. The spatial filter may be a simple average of the eight-connected neighbors or it may be an interpolative filter. The same correlation process (step 96) as described above can be used to down select only those pixels that are malfunctioning in a given image. Note, over inclusion is less of a problem when using the spatial filter technique. Even if the filter is misapplied, the corrected pixel value is an average of its neighbors and thus will be fairly close albeit with a little bit of smoothing. By contrast, if the subtraction is misapplied a fairly large (bright) output value may be subtracted incorrectly from a pixel.

The other approach is to generate a correction map associated with the particular CCD camera used to capture the sequence of digital images. This requires the manufacturer to generate an inventory of maps for the cameras and make them available to post-production. It also requires the identification of the CCD camera to be provided with the images. Using multi-valued correction maps for a particular CCD camera is not very practical. The manufacturer would have to generate a map for each level of under exposure and the post-house would have to match the correct map to the sequence of images. Estimating exposure level from the images is a difficult and unreliable process. Instead, our approach would generate a single binary correction map for each CCD camera for the possible range of under exposed levels. An embodiment for generating such a map is illustrated in FIG. 11.

The first step is to select and identify a digital CCD camera (step 100). A minimum exposure level is set (step 102) and one or more images are captured (step 104). The images would have no content to provide the most controlled results. Multiple images would capture any temporal instability of possibly malfunctioning pixels. The malfunctioning pixels are logically accumulated (step 106). A map having a one-to-one relationship with the highest resolution of the camera is initialized to zero. If a pixel in any of the captured images malfunctions (bright), the map value is set to one. Once the minimum exposure level is reached (step 108) the accumulated map is output as the binary correction map 110 and the map is associated with the particular CCD camera (step 112). Until the minimum exposure level is reached, the exposure level is incremented (step 114) and steps 104 and 106 are repeated. The effect of the logical accumulation is to “OR” the binary correction maps associated with each of the exposure levels. Because under exposed pixels are unstable, they may operate normally at some exposure levels and malfunction at others. The OR'd correction map 110 is generally over inclusive in identifying malfunctioning pixels for any particular exposure level. But the correlation and validation steps described previously that may be used to apply the correction map should eliminate the over included pixels for any sequence of images captured at a particular exposure level and for any image in the sequence in which certain pixels are masked by sufficiently bright content. This process should be repeated by the manufacturer for each of its CCD cameras and stored in an inventory that can be accessed by a post-house. The workstation would receive the identification number of the CCD camera using a mechanism such as metadata from the captured media files and download the correction map from the manufacturer inventory via, for example, a Internet accessible database.

While several illustrative embodiments of the invention have been shown and described, numerous variations and alternate embodiments will occur to those skilled in the art. Such variations and alternate embodiments are contemplated, and can be made without departing from the spirit and scope of the invention as defined in the appended claims.

I claim:

1. A method of static pattern removal from movies captured with a digital CCD camera, comprising:
receiving a sequence of digital moving images captured with a digital CCD camera;
providing a correction map of malfunctioning underexposed CCD pixels; and
applying the correction map to the digital moving images to reduce the effects of malfunctioning underexposed CCD pixels.

2. The method of claim 1, wherein the images having an approximately uniform exposure level, the step of providing the correction map, comprises:
high pass filtering each image in the sequence to provide filtered images;
averaging the filtered images to generate a multi-valued correction map.

3. The method of claim 2, further comprising:
thresholding the multi-valued correction map to produce a binary correction map.

4. The method of claim 1, wherein the step of providing the correction map, comprises:
generating binary correction maps for an inventory of CCD cameras offline;
identifying the particular CCD camera used to capture the sequence of images; and
downloading the binary correction map for the particular CCD camera.

5. The method of claim 1 wherein the step of applying the correction map to each image comprises:
correlating the correction map or variant thereof to the image or a high-pass filtered version of the image to identify the malfunctioning underexposed pixels in the image; and
spatial filtering each of the identified malfunctioning underexposed pixels in the image to replace the output value of the pixel with a corrected output value.

6. The method of claim 1, wherein the step of applying the correction map to each image comprises:
spatial filtering each of the malfunctioning underexposed pixels in the image as identified by the correction map to replace the output value of the pixel with a corrected output value.

7. The method of claim 6, wherein the correction map is a binary map having a first binary value that indicates functioning pixels and a second binary value that indicates malfunctioning underexposed pixels.

8. The method of claim 1, wherein the correction map is a multi-valued map having pixel output values that are a measure of the brightness of malfunctioning underexposed pixels.

9. The method of claim 8, wherein the step of applying the correction map to each image comprises:
subtracting the output values for the malfunctioning underexposed pixels from the image.

10. The method of claim 9, wherein all of the output values for the entire correction map are subtracted from the image.

11. The method of claim 9, further comprising prior to the subtraction step the step of:
correlating the correction map or a variant thereof to the image or a high-pass filtered version of the image to identify the malfunctioning underexposed pixels in the image

12. An apparatus for static pattern removal from movies captured with a digital CCD camera, comprising:
First computer means for receiving a sequence of digital moving images captured with a digital CCD camera;
Second computer means for providing a correction map of malfunctioning underexposed CCD pixels; and
Third computer means for applying the correction map to the digital moving images to reduce the effects of malfunctioning underexposed CCD pixels.

13. The apparatus of claim 12, wherein said second and third computer means automatically provide and apply the correction map to the digital moving images without user intervention.

14. The apparatus of claim 12, wherein said second computer means high pass filters each image in the sequence and averages the filtered images to generate a multi-valued correction map having pixel output values that are a measure of the brightness of malfunctioning underexposed pixels and said third computer means subtracts the output values for the malfunctioning underexposed pixels from the image.

15. The apparatus of claim 14, wherein said third computer means subtracts all of the output values for the entire correction map from the image.

16. The apparatus of claim 12, wherein said second computer means identifies the particular CCD camera used to capture the sequence of images from data in said sequence and downloads a binary correction map for the particular CCD.

17. The apparatus of claim 12, wherein the third computer means correlates the correction map or variant thereof to each said image or a high-pass filtered version of the image to first identify the malfunctioning underexposed pixels in the image and than corrects the identified pixels.

18. The apparatus of claim 17, wherein the third computer means spatial filters each of the identified malfunctioning underexposed pixels in each said image to replace the output value of the pixel with a corrected output value.

19. A method of static pattern removal from movies captured with a digital CCD camera, comprising:
receiving a sequence of digital moving images captured with a CCD camera at an approximately uniform exposure level;
high pass filtering each image in the sequence to provide filtered images;
averaging the filtered images to generate a correction map of malfunctioning underexposed CCD pixels; and
applying the correction map the digital moving images to reduce the effects of the malfunctioning underexposed CCD pixels.

20. The method of claim 19, wherein the step of applying the correction map to each image comprises correlating the correction map or variant thereof to the image or a high-pass filtered version of the image to identify the malfunctioning underexposed pixels in the image.

21. The method of claim 20, wherein the step of applying the correction map to each image further comprises spatial filtering each of the identified malfunctioning underexposed pixels in the image to replace the output value of the pixel with a corrected output value.

22. The method of claim 20, wherein the correction map is a multi-valued map having pixel output values that are a measure of the brightness of malfunctioning underexposed pixels, the step of applying the correction map to each image further comprising subtracting the output values for the malfunctioning underexposed pixels from the image.

23. A method of static pattern removal from movies captured with a digital CCD camera, comprising:
receiving a sequence of digital moving images captured with a known CCD camera at an approximately uniform exposure level;
retrieving a correction map of malfunctioning underexposed CCD pixels for the known CCD;
using the correction map to selectively spatial filter the original images to replace the malfunctioning underexposed CCD pixels.

24. The method of claim 23, further comprising:
generating correction maps for an inventory of CCD cameras;
storing the correction maps in an Internet accessible database;
inserting data in the sequence of images identifying the known CCD camera; and
downloading the correction map for the identified CCD camera from the Internet accessible database.

25. The method of claim 23, further comprising, prior to spatial filter, correlating the correction map or variant thereof to the image or a high-pass filtered version of the image to identify the malfunctioning underexposed pixels in the image.

26. An apparatus for static pattern removal from movies captured with a digital CCD camera, comprising:
A storage unit for storing a sequence of digital moving images captured with a digital CCD camera and a correction map of malfunctioning underexposed CCD pixels; and
A processor configured to apply the correction map to the digital moving images to reduce the effects of malfunctioning underexposed CCD pixels.

27. The apparatus of claim 26, wherein the processor is configured to automatically generate the correction map from the sequence of digital moving images and then automatically apply the correction map to each of the images without user intervention.

28. The apparatus of claim 27, wherein the processor is configured to high pass filter each image in the sequence and average the filtered images to generate the correction map.

29. The apparatus of claim 28, wherein the correction map has pixel output values that are a measure of the brightness of malfunctioning underexposed pixels, said processor configured to subtract the output values for the malfunctioning underexposed pixels from each said image.

30. The apparatus of claim 28, wherein said processor is configured spatial filters each of the identified malfunctioning underexposed pixels in each said image to replace the output value of the pixel with a corrected output value.

31. A computer program product comprising a computer useable medium having computer program logic recorded thereon for enabling a processor to perform static pattern removal from movies captured with a digital CCD camera, the computer program comprising:
A first procedure that configures the processor to provide a correction map of malfunctioning underexposed CCD pixels for a sequence of digital moving images captured with a digital CCD camera; and
A second procedure that configures the processor to apply the correction map to the digital moving images to reduce the effects of malfunctioning underexposed CCD pixels.

32. The computer program product of claim 31, wherein said first and second procedures configure the processor to automatically generate the correction map from the sequence of digital moving images and then automatically apply the correction map to each of the images without user intervention.

33. The computer program product of claim 32, wherein the first procedure configures the processor to high pass filter each image in the sequence and average the filtered images to generate the correction map.

34. The computer program product of claim 32, wherein the correction map has pixel output values that are a measure of the brightness of malfunctioning underexposed pixels, said second procedure configures the processor to subtract the output values for the malfunctioning underexposed pixels from each said image.

35. The computer program product of claim 32, wherein the second procedure configures the processor to spatial filter each of the identified malfunctioning underexposed pixels in each said image to replace the output value of the pixel with a corrected output value.
